(19) United States
(12) Patent Application Publication
(10) Pub. No.: US 2021/0381871 A1
(43) Pub. Date: Dec. 9, 2021

(54) Dispensing apparatus for dosing flowable media

(71) Applicants: Ludwig EICHENSEHER, Muhlhausen (DE); Tobias STURM, Hemau (DE)

(72) Inventors: Ludwig EICHENSEHER, Muhlhausen (DE); Tobias STURM, Hemau (DE)

(21) Appl. No.: 16/897,914

(22) Filed: Jun. 10, 2020

(30) Foreign Application Priority Data
Jun. 8, 2020 (DE) 10 2020 115 144.6

(51) Int. Cl. G01F 11/00; G01F 11/02

(52) U.S. Cl. CPC G01F 11/006; G01F 11/023

(57) ABSTRACT

The present invention relates to a dispensing apparatus for dosing flowable media, which comprises at least one housing, at least one storage container exchangeably arranged in the housing having at least one pump apparatus and at least one actuating apparatus, the pump apparatus being arranged on the upper side or underside of the storage container and consisting of at least one pump unit and one outlet element. At least one outlet pipe is provided on the housing for at least partially receiving the outlet element of the pump apparatus (4), the actuating apparatus consisting of at least one via an actuating element, by means of which the pump apparatus can be driven, such that the flowable media can be dosed when flowing out of the outlet pipe.

The invention relates to a dispensing apparatus for dosing flowable media in accordance with the preamble of claim 1.

Liquid dispensers that dose a liquid under pressure via a pump mechanism are known from many areas of daily use and are used, for example, as soap dispensers or as dispensers for disinfectants or hand lotions in the hygiene sector. Commercially available liquid soap dispensers are often designed as pre-filled disposable dispensers, in particular for domestic use, and are sold in large quantities. In public facilities, dispensing apparatuses are proposed for precise dosing or portioning, but also for hygiene reasons, and can be actuated, for example, via foot pedals.

For example, DE 200 13 253 U 1 specifies an actuating apparatus for a portioning device, in particular a soap dispenser, in which the portioning device connected to a soap storage container can be actuated by means of a pulling element, the pulling element being connected to a pedal arranged in the floor region. Furthermore, DE 695 09 880 T2 describes a test apparatus for atomising cosmetic products, in which a liquid cosmetic product is atomised from a bottle equipped with a pressure-activated atomising valve via distribution and actuating means. The bottle standing on a plate is pushed vertically upwards when the actuating means, for example a foot pedal, is actuated. The pressure-activated atomising valve is pressed against a stop plate by this lifting, whereby an atomising process is triggered, and the cosmetic product is dispensed via the distribution means designed as a tube.

Dispensers for dosing liquid or viscous or flowable media, in particular foodstuffs, are also known from the food processing or food trade sectors or in the catering industry and are used, for example, as mustard, ketchup or mayonnaise dispensers. Especially in canteen kitchens, at kiosks or in mass catering or in the “fast food” sector, dispensers are necessary which can hold large volumes of flowable media and are as easy to use and at the same time as hygienically safe to use as possible.

However, there is no dispensing apparatus, in particular for dispensing disinfectant and/or water and/or another fluid, of which the viscosity differs only slightly from that of disinfectant and/or water.

There is also no dispensing apparatus for dispensing liquid or viscous or flowable media, in particular foodstuffs, such as, for example, mustard dispensers, ketchup dispensers or mayonnaise dispensers, which is of particularly simple construction and in particular is also particularly inexpensive to produce.

A deviation from the viscosity of water and/or the disinfectant to be used is preferably up to 10%, particularly preferably up to 5%, allowed and can be pumped through the dispensing apparatus. A temperature of the flowable medium of 10 degrees Celsius can be assumed as the reference temperature, the physical unit Pas having to apply with regard to the viscosity.

On this basis, the object of the invention is based, inter alia, on providing a dispensing apparatus for dosing flowable media which, with simple handling, permits clean, perfectly hygienic removal of the flowable medium. The object is achieved on the basis of the features of the preamble of claim 1 by the characterising features thereof.

According to at least one embodiment, the dispensing apparatus for dosing flowable media, in particular disinfectant and/or water (for example holy water; holy water is often mixed with an additive, for example. Such additives can be oils, fragrances, etc.), has at least one storage container arranged exchangeably in the housing having at least one pump apparatus and at least one actuating apparatus, the pump apparatus being arranged on the upper side or underside of the storage container and consisting of at least one pump unit and one outlet element.

At least one outlet pipe or at least one other outlet element is provided on the housing for at least partially receiving the outlet element of the pump apparatus, the actuating apparatus having at least one actuating element by means of which the pump apparatus can be driven, such that the flowable media can be dosed when flowing out of the outlet pipe.

A dispensing apparatus for dosing flowable media, which is presented here, has a housing, at least one storage container exchangeably arranged in the housing having at least one pump apparatus and having at least one actuating apparatus. The pump apparatus is arranged on the upper side or underside of the storage container and consists of at least one pump unit and one outlet element. The invention is characterised in particular by the fact that at least one outlet pipe is provided on the housing for at least partially receiving the outlet element of the pump apparatus,

According to at least one embodiment, a collecting container is arranged in the vertical direction below an opening of the outlet pipe, such that excess amounts of the flowable media are stored therein. In the present invention, “arranged below the opening” means a collecting container arranged along the main extension direction of the dispenser (and thus generally from the assembly floor up to the dispenser opening).

According to at least one embodiment, such a fluid volume flows out of the outlet pipe at the maximum by means of a single actuation of the pumping apparatus by the actuating apparatus, such that the storage container fills to a maximum of at most 5%, preferably at most 10%. This can be a stroke filling limitation, such that the collecting container only starts to fill up after a specific number of strokes, in particular a plurality, in particular a multiplicity, of individual strokes.

In accordance with at least one embodiment, the fluid volume which flows out of the outlet opening can be adjusted by means of a single actuation of the pumping apparatus.

In accordance with at least one embodiment, the adjustment of the fluid volume takes place by an adjustment means which adjusts a stroke volume of the pumping apparatus. An adjustment can be made using an adjustment means which can be adjusted either manually or else pneumatically and/or electrically. A stroke quantity adjustment can also be carried out continuously or in stages by a corresponding actuation of the pumping device and/or by the above-mentioned adjustment means by the user.

In accordance with at least one embodiment, the pumping apparatus has an actuating element which is designed as a foot pedal. By means of the actuating element, the pumping apparatus can be actuated for pumping solely by pressure point loading of the actuating element by a foot of the user. For this purpose, the dispensing apparatus can be operated purely mechanically by foot pressure, or the load can be applied pneumatically and/or electrically. A combination of mechanical load and pneumatic and/or electrical load is also conceivable. Instead of the actuating element, another triggering means can also be actuated, such as a mechanical and/or electrical switch.

According to at least one embodiment, at least one further storage container is arranged inside the housing or on the outside of the housing, which is configured and provided to store the flowable medium and/or is configured and provided to store an operating resource, such as coins or notes. It is also conceivable that the further storage container is installed as a storage container into which donations, such as coins and the like can be stored. The storage container can be a so-called offertory box.

According to at least one embodiment, the pumping apparatus is activated for a predetermined number of pump strokes and/or for a predetermined time unit and/or for a predetermined time interval, depending on the operating resource.

In accordance with at least one embodiment, the storage container comprises or is an offertory box.

In an embodiment of the dispensing apparatus by way of example, this has a type of double tube or pipe guide, wherein the outlet element of the pump apparatus forms an inner tube which is in contact with the flowable medium and the outlet pipe (or the general outlet element) arranged on the housing provides an outer pipe guiding the inner tube.

In general, however, any tube element can also be replaced by a pipe element or by another fluid-carrying element in the sense of the invention.

The outlet element can thus substantially serve as a guide element, namely as a protective and stabilising guide for the outlet element connected to the pump unit. Starting from the pump unit, the outlet element thus initially runs freely through the interior of the housing, enters the outlet tube at or near the housing wall through the opening, facing the interior of the housing, of the outlet pipe (or more generally “of the outlet element”) and extends guided by the outlet pipe approximately up to the free end thereof which is outwardly aligned.

The outlet element thus extends, for example, over the entire length of the outlet pipe.

In this way, the outlet pipe or the inside of the wall of the outlet pipe does not come into contact with the flowable medium transported via the outlet element in a particularly advantageous manner. It goes without saying that this is of particular advantage from a hygiene point of view, since the outlet pipe arranged on the housing remains clean and therefore does not have to be subjected to a special cleaning procedure.

In addition, due to this double tube or pipe guide, the risk of germs entering the storage container is largely eliminated, and possible recontamination from the mouth of the outlet pipe can thus be effectively prevented.

The opening of the outlet element facing the interior of the housing is preferably arranged on or near the housing wall. The outlet element is preferably guided through a recess in the housing wall and fastened, for example, to the housing wall in such a way that the opening facing the interior of the housing is arranged on the inner surface of the housing wall, such that the outlet pipe does not extend into the interior of the housing, but instead ends on the inner surface of the housing wall. The flexible outlet tube of the pump apparatus can thus be inserted comfortably from the interior of the housing into the outlet pipe.

The outlet element, together with the pump unit, forms the pump apparatus, which is arranged above the storage container, for example.

The pump apparatus is placed, for example, from above onto the storage container or onto a lid of the storage container having a recess and is adequately fastened there.

The pump unit of the pump apparatus has, for example, a vertically displaceable operating pressure piece, preferably a push button.

By pressing the operating pressure piece from above, the operating pressure piece can be moved downwards in the vertical direction, whereby a pump mechanism or a pumping process is triggered. With this pump mechanism, the flowable medium is conveyed into the outlet tube and can be dosed.

The pressure on the operating pressure piece and thus the triggering of the pumping process takes place in the present invention by means of an actuating apparatus.

This actuating apparatus, consisting for example of a lifting table unit and a stop plate, is to be seen as a further possible aspect of the present dispensing apparatus according to the invention.

The lifting table unit of the actuating apparatus can be operated via an actuating element and is provided for lifting the storage container placed thereon. The stop element is arranged above the pump apparatus and serves as a stop for the operating pressure piece.

By actuating the actuating element, the storage container standing on the lifting table unit is lifted with its pump apparatus placed on the upper side thereof, namely shifted upwards in the vertical direction. It goes without saying that the pump unit placed on the storage container is also moved upwards with its operating pressure piece, as a result of which the operating pressure piece is brought up to the stop element arranged above the pump apparatus or the operating pressure piece and finally abuts there. When lifting further, the stop element presses on the operating pressure piece, which is thereby shifted downwards in the vertical direction. The pump mechanism for dosing the flowable medium is triggered.

Dosing or portioning a flowable medium, such as the disinfectant, is particularly advantageously possible by means of the actuating apparatus of the dispensing apparatus according to the invention in a particularly simple and at the same time clean, perfectly hygienic manner.

Each user triggers the pump mechanism and thus ultimately the output of a portion size of the flowable and pumpable fluid via an actuating element arranged away from the fluid (generally via an actuating element).

The users do not need to directly touch the pump apparatus and thus, also in the broader sense, the storage container using their hands.

The risk of contamination of the user with bacteria and/or viruses is precluded by the fact that the dispensing device is operated in a particularly hygienic manner. Bacteria and viruses carried by other people simply cannot penetrate into the fluid. Not only does the fluid remain contamination-free throughout the use thereof, it also causes further contamination and therefore no infection chain.

Just as advantageously, the pressure force impinging on the actuating element (for example the lever or an operating pressure piece) is preferably directed vertically downwards, as a result of which twisting or tilting of the pump unit can be avoided. The lifting path or the stroke distance or stroke height for the lifting table unit can also be specified via the exemplary actuating element, by means of which a defined portion size for the foodstuff to be dosed can be adjusted and precise dosing is possible.

According to a preferred embodiment of the present invention, the outlet element of the pump apparatus can be detachably connected to the pump unit and particularly preferably is designed in the form of a consumable element, in particular as a disposable tube piece or pipe piece. The outlet element can be connected to the pump unit of the pump apparatus via a releasable connecting means, for example a screw connection or plug connection.

The outlet element and/or the outlet pipe are preferably exchangeable.

A stop element designed as an integral plate, in particular as a cover element or as a cover surface of the housing, can be advantageous. The stop element designed as the cover surface of the housing can be connected fixedly or detachably to the front, rear and/or side walls of the housing. For example, it is conceivable that the cover surface, namely the stop element, is connected to one of the front, rear and/or side walls of the housing via hinges so as to be movable or foldable. In alternative embodiments, however, an integral plate arranged in the housing and firmly connected to the housing can also be provided as a stop element in addition to the cover surface.

In particular, the actuating element can be designed as a foot pedal. Upon actuation of the actuating element designed as a foot pedal, a downward operating pressure is deflected and results in an upward stroke of the lifting table unit and the storage container placed thereon. The exemplary articulated connection between the foot pedal and the lifting rod ensures that the substantially vertically oriented operating pressure is in turn reversed into a vertical, but upward, stroke, the direction of force of the stroke being substantially parallel to the main axis of the dispensing apparatus. The design of the actuating element as a foot pedal (or as another control element, such as a pulling or pushing element) has the advantage that a user of the dispensing apparatus can have both hands free and cannot contaminate it.

An advantage can also result from the fact that an integral plate is preferably designed as a common stop element. This arrangement makes it possible, for example, to start a separate pumping process for each individual storage container. For example, when a specific foot pedal is actuated, the associated storage container is raised with the pump apparatus thereof, as a result of which the corresponding operating pressure piece is guided to the common stop element and is pressed down thereby. The foodstuff presented in the various storage containers can be removed individually according to individual user requirements.

To facilitate transport of the dispensing apparatus, the housing has castors on the underside, for example, and/or handles are provided on the outside of the housing. A storage area provided on the outside of the housing, in particular in the form of a projecting plate, is also advantageous. The housing and the outlet pipes and the lifting table unit are made particularly advantageously of a metal, preferably of steel, particularly preferably of stainless steel.

The present invention therefore also relates, inter alia, to such a dispenser which differs from a dispensing apparatus for dosing flowable media, provided that these media are ketchup, mayonnaise or other sauces and/or other dispensable foodstuffs. However, the invention presented here does not exclude a sauce dispenser per se.

In particular, the present invention can therefore be such a dispensing apparatus which is configured and provided to dispense in a controlled manner a disinfectant and/or water and/or another fluid, of which the viscosity deviates only marginally from that of disinfectant and/or water. A deviation from the viscosity of water and/or the disinfectant to be used is preferably up to 10%, particularly preferably up to 5%, allowed and can be pumped through the dispensing apparatus. A temperature of the flowable medium of 10 degrees Celsius can be assumed as the reference temperature, the physical unit Pas having to apply with regard to the viscosity.

In this respect, the present dispensing apparatus can be a disinfection dispensing apparatus. It is also conceivable that the dispensing apparatus is therefore also a water dispenser, in particular a holy water dispenser.

In at least one embodiment, the present invention in particular does not include any sauce dispensers by means of which corresponding sauces or other foodstuffs can be dispensed. In such a case, water is not considered to be foodstuff.

For this purpose, an opening of the outlet pipe can be measured so small that such sauces, such as ketchup or mayonnaise, cannot be passed through or out. With such an opening in the outlet pipe, if an attempt were made to dispense such sauces, this would result in a backflow and thus a blockage of the entire dispensing apparatus.

A fluid guide diameter within the outlet element and/or the outlet pipe is preferably not greater than 3 mm, preferably less than 2 mm and more preferably less than 1 mm, and particularly preferably less than 0.5 mm.

However, a sauce dispenser is not explicitly excluded within the scope of the invention. Such a sauce dispenser can also have such cross-sectional dimensions. Then, however, thin liquid corresponding to such sauces.

Furthermore, the opening on the outlet element can have at least one nozzle apparatus which centres the fluid flow and concentrates on a very small outlet point, in particular namely at the end of the outlet element, i.e. at the position of the opening of the outlet element.

The same can apply to the nature of the outlet pipe because the outlet pipe also has an opening through which the fluid to be dispensed preferably flows out of the dispensing apparatus. This opening can also have a cross-sectional value of at most 2 mm, preferably of at most 1 mm and very particularly preferably of at most 0.5 mm, wherein a corresponding outlet nozzle can also be provided here, which either concentrates the fluid in a punctiform manner or at least partially atomises it.

If the fluid flow is concentrated onto at least one point or a point-like location, it can be a spinning nozzle.

In the case of atomisation, it can be a confuser or a diffuser. A confuser is the counterpart of a diffuser. In a confuser, the speed of the fluid increases in contrast to the diffuser in which the fluid flowing through is braked. The geometry of the confuser and diffuser depends on the Mach number of the flowing fluid; while at subsonic speed a tapering cross section acts as a confuser and another cross section acts as a diffuser, the relationship is reversed at supersonic speed.

However, a supersonic speed is preferably avoided in the present invention. This occurs simply because the pumping apparatus proposed here is not strong enough to be able to transport the fluid even if only up to near a supersonic speed.

Basically, the nozzle proposed here uses only the kinetic energy that either comes from the opening of the outlet element or the opening of the outlet pipe. A pressure difference is therefore applied to the liquid by means of the pumping apparatus. This results in a specific flow velocity of the fluid such that the liquid jet can disintegrate, for example, individual jets or atomising drops, so that individual drops can form due to the turbulent flow, which can be realized in the form of a spray jet. In addition, aerodynamic effects resulting from the interaction with the surrounding atmosphere of drop formation must be taken into account.

As already mentioned above, however, the present invention can also be free from such a nozzle (geometry), such that the outlet of either the outlet pipe or the outlet element is in particular only determined via the outlet cross section.

According to at least one embodiment, at least one inner surface of the fluid line tube (liquid channel) of the outlet of the outlet pipe and/or of the outlet element has at least partially an antibacterial and/or antiviral coating. Among other things, this also serves to kill bacteria and/or viruses located on the inner surface and/or in the fluid to be pumped. The coating can be an activated carbon coating. It is also conceivable that the coating is formed with another antibacterial material, such as brass. It is even conceivable that at least parts of the outlet and/or the outlet element are formed with an antibacterial material.

According to at least, the apparatus described here comprises at least one filter element which is arranged, for example, between the outlet pipe and the outlet element and which at least partially filters out impurities from the fluid to be dispensed and/or likewise already kills and/or filters out bacteria and/or viruses. The filter can be an activated carbon filter. It is also conceivable that a filter element, such as an activated carbon filter, is positioned at the end of the outlet pipe and/or the outlet element. The filter element therefore does not have to be arranged inside the housing, but can instead be re-positioned from the outside into the outlet pipe/or the outlet element. For this purpose, it is conceivable that the filter or one of the parts of the outlet element which has the inner coating is placed on the outlet pipe, screwed on, or is otherwise positioned in a mechanically stable manner.

It is also conceivable that the inner surface of the nozzle, which is arranged on the outer end of the outlet pipe and/or the outlet element, also has an antibacterial and/or antiviral coating, for example of the same type as described above.

Furthermore, the liquid channel can have at least a reduction in cross section in the form of an hourglass, such that a constriction first appears in the direction from the outlet pipe to the outlet element, which constriction can be overcome by the fluids to be discharged, in order then to be discharged from the outlet element. Experience has shown that, particularly after the tapping process (=dosing process), a residual drop can be avoided. On the basis of the Bernulli and capillary effects, after the tapping process has ended, it can be avoided that further drops leave the liquid channel, and the tapping process can also be ended very quickly, in particular also abruptly.

According to at least one embodiment, a cross section of the liquid channel above the constriction is smaller, at least 5% smaller than the cross section of the liquid channel below the constriction.

However, it is still conceivable that a nozzle apparatus is arranged on an outlet opening, for example the opening of the outlet pipe, for example screwed on or otherwise fastened. In this context, it is conceivable that the nozzle apparatus is a hollow cone nozzle or a mushroom head nozzle.

This excludes the use of sauces or other viscous or semi-viscous foodstuffs.

The invention is explained in more detail below with reference to the drawings.

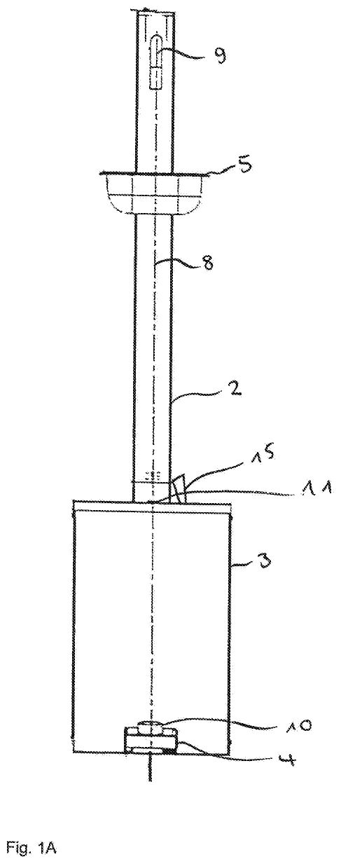

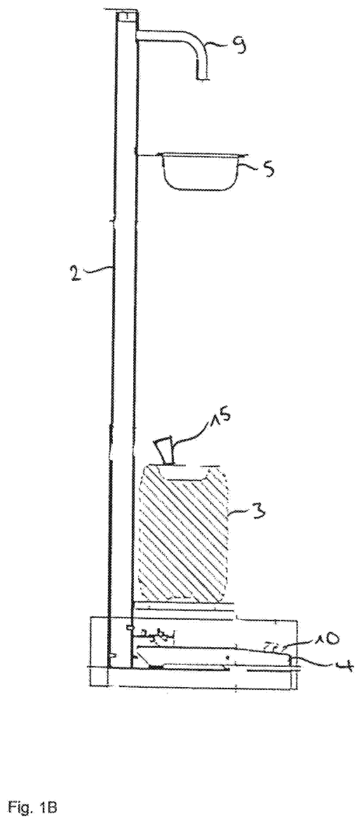

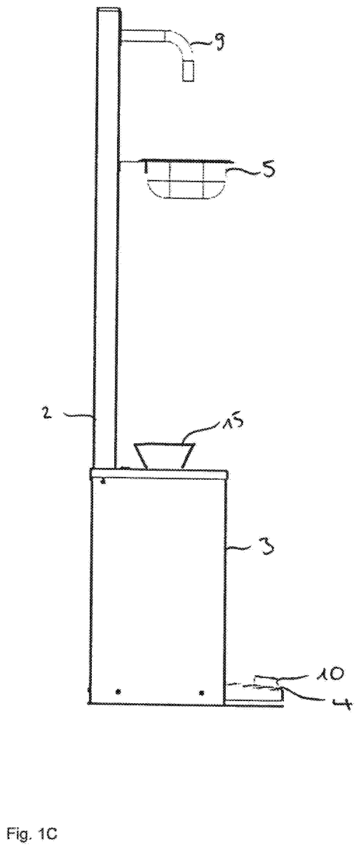

FIGS. 1A to 1C are schematic side views (FIG. 1B is a cross-sectional side view) of an embodiment of a first implementation of the present invention.

FIG. 1D shows a holding element for holding the collecting container.

FIG. 1E is a schematic plan view of the invention described here according to FIG. 1A to 1D,

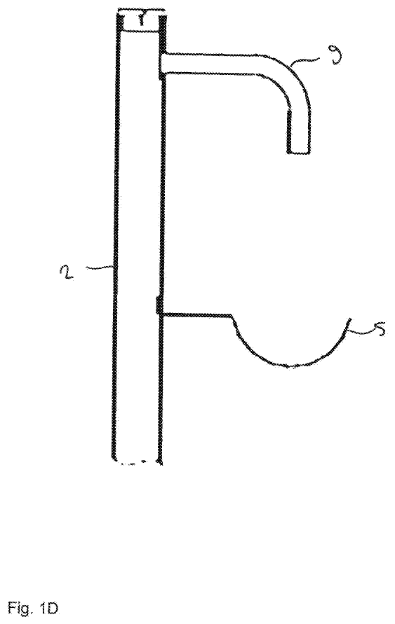

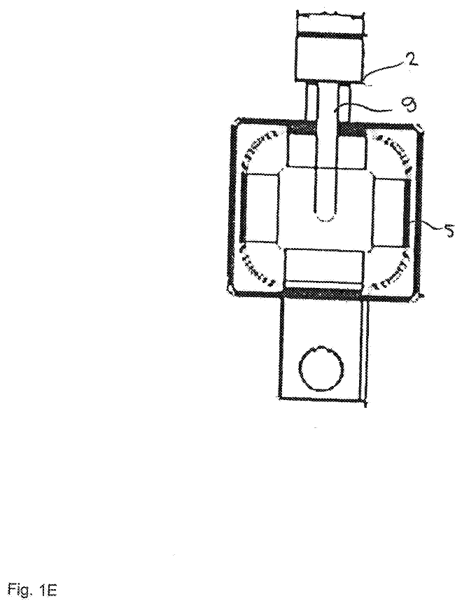

FIG. 2 showing a detail of the lever region of the present invention.

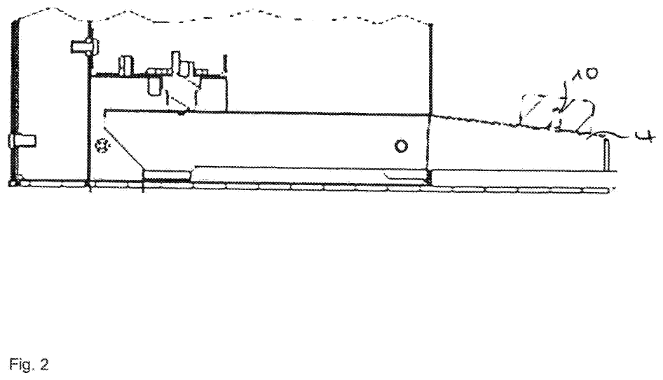

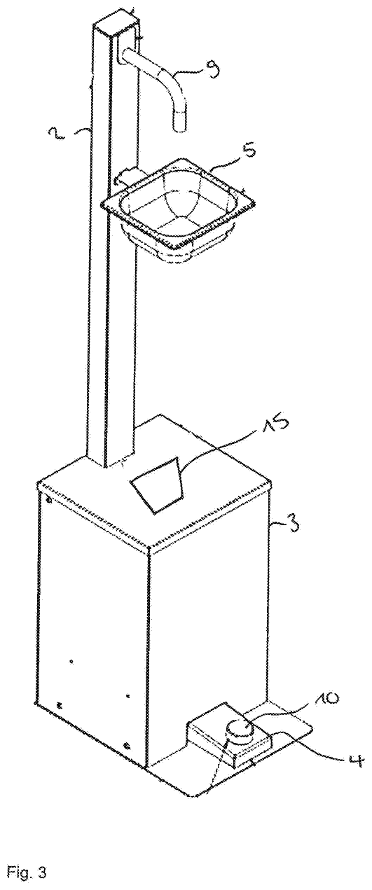

FIG. 3 is a schematic perspective view of the embodiment according to FIG. 1A to 2.

In the drawings, identical or equivalent components are provided with the same components, even if individual components may be exaggerated.

The dispensing apparatus 1 has a housing 2, at least one storage container 3 arranged exchangeably in the housing 2 having at least one pump apparatus 4 and at least one actuating apparatus, in particular wherein the pump apparatus 4 is arranged on the upper side or underside of the storage container 3 and consists of at least one pump unit 6 and one outlet element 8. At least one outlet pipe 9 is provided on the housing 2 for at least partially receiving the outlet element 8 of the pump apparatus 4, the actuating apparatus consisting of at least one via an actuating element 10, by means of which the pump apparatus 4 can be driven, so that the flowable media can be dosed when flowing out of the outlet pipe 9.

A collecting container is arranged in the vertical direction below an opening of the outlet pipe 9, such that excess amounts of the flowable media are stored therein.

Such a fluid volume flows out of the outlet pipe (9) at the maximum by means of a single actuation of the pumping apparatus 4 by the actuating apparatus, such that the storage container fills to a maximum of at most 5%, preferably at most 10%.

The fluid volume, which flows out in particular from the outlet opening by means of a single actuation of the pumping apparatus 4, can be adjusted here

The adjustment of the fluid volume takes place using an adjustment means, which in particular adjusts a stroke volume of the pumping apparatus 4.

In addition, the pumping apparatus has an actuating element 10, which is designed here as a foot pedal.

At least one further storage container 15 is arranged inside the housing 2 or on the outside of the housing 2, which storage container is in particular configured and provided to store the flowable medium or else is configured and provided to store an operating resource, such as coins or notes.

Depending on the operating resource, the pumping apparatus is activated for a predetermined number of pump strokes.

The storage container in this case is or comprises an offertory box.

In the present invention, the housing 2 and the outlet pipe 9 and the lifting table unit 11 are made of metal, preferably steel, in particular stainless steel.

### LIST OF REFERENCE NUMERALS

1 dispensing apparatus
2 housing
3 storage container
4 pump apparatus
5 storage area
8 outlet element
9 outlet pipe
10 actuating element
11 lifting table unit

1. Dispensing apparatus (1) for dosing flowable media, comprising a housing (2), at least one storage container (3) exchangeably arranged in the housing (2) having at least one pump apparatus (4) and at least one actuating apparatus, the pump apparatus (4) being arranged on the upper side or underside of the storage container (3) and consisting of at least one pump unit (6) and one outlet element (8), characterised in that at least one outlet pipe (9) is provided on the housing (2) for at least partially receiving the outlet element (8) of the pump apparatus (4), the actuating apparatus consisting of at least one via an actuating element (10), by means of which the pump apparatus (4) can be driven, such that the flowable medium can be dosed when flowing out of the outlet pipe (9).

2. Dispensing apparatus (1) according to claim 1, characterised in that a collecting container is arranged in the vertical direction below an opening of the outlet pipe (9), such that excess amount of the flowable media is stored therein.

3. Dispensing apparatus (1) according to claim 1, characterised in that such a fluid volume flows out of the outlet pipe (9) at the maximum by means of a single actuation of the pumping apparatus (4) by the actuating apparatus, such that the storage container fills to a maximum of at most 5%, preferably at most 10%.

4. Dispensing apparatus (1) according to claim 1, characterised in that the fluid volume which flows out of the outlet opening by means of a single actuation of the pumping apparatus (4) is adjustable.

5. Dispensing apparatus (1) according to claim 4, characterised in that the adjustment of the fluid volume takes place via an adjustment means which adjusts a stroke volume of the pumping apparatus (4).

6. Dispensing apparatus (1) according to claim 1, characterised in that the pumping apparatus has an actuating element (10) which is designed as a foot pedal.

7. Dispensing apparatus (1) according to claim 1, characterised in that at least one further storage container (15) is arranged inside the housing (2) or on the outside of the housing (2), which is configured and provided to store the flowable medium or else is configured and provided to store an operating resource, such as coins, notes.

8. Dispensing apparatus (1) according to claim 1, characterised in that the pumping apparatus is activated for a predetermined number of pump strokes depending on the operating resource.

9. Dispensing apparatus (1) according to claim 1, characterised in that the storage container is or comprises an offertory box.

10. Dispensing apparatus (1) according to claim 1, characterised in that the housing (2) and the outlet pipes (9) and the lifting table unit (11) are made of metal, preferably steel, in particular stainless steel.
